(19) United States
(12) Patent Application Publication
(10) Pub. No.: US 2008/0118714 A1
(43) Pub. Date: May 22, 2008

(54) Thermoplastic composite sheet material

(76) Inventor: Kuang Cheng Chao, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/602,229

(22) Filed: Nov. 21, 2006

(51) Int. Cl. B32B 3/10

(52) U.S. Cl. 428/195.1

(57) ABSTRACT

A thermoplastic composite sheet material suitable for injection-molding into shaped shell members for electric and electronic products is disclosed to have a top fabric face layer digital-printed or transfer-printed with a design, a bottom thermoplastic sheet member, and a bonding agent sandwiched between the top fabric face layer and the thermoplastic sheet member.

### BACKGROUND OF THE INVENTION

1. Field of the Invention

The present invention relates fabrics and more particularly, to a thermoplastic composite sheet material, which is comprised of a top fabric layer, a bottom thermoplastic sheet member, and a bonding agent sandwiched between the top fabric face layer and the thermoplastic sheet member, and which is suitable for injection-molding into shaped shell members for electric and electronic products.

2. Description of the Related Art

FIGS. 1 and 2 illustrates the composition structure of a conventional thermoplastic fabric. This thermoplastic fabric is comprised of a top fabric layer 12 and a bottom thermoplastic reinforcing layer 13. The top fabric layer 12 is a woven fabric made out of regular fiber threads. The bottom thermoplastic reinforcing layer 13 is a woven fabric made out of reinforcing thermoplastic fiber threads and regular fiber threads. Each reinforcing thermoplastic fiber thread is comprised of a fiber core 11 and a low melting point polyester sheathe layer 10 sleeved onto the fiber core 11. The thermoplastic fabric is processed by a hot press to melt the low melting point polyester sheathe layer 10, causing the molten polyester sheathe layer 10 to be evenly distributed in the bottom thermoplastic reinforcing layer 13. When the molten polyester is hardened, the desired thermoplastic fabric is thus obtained.

There is known another structure of thermoplastic fabric, which is comprised of three stacked layers, namely, the top fabric layer, the intermediate lying layer, and the bottom thermoplastic reinforcing layer. The bottom thermoplastic reinforcing layer is made in the same, manner as the bottom thermoplastic reinforcing layer 13 of the thermoplastic fabric shown in FIGS. 1 and 2.

The aforesaid two different kinds of thermoplastic fabrics have drawbacks. These two different kinds of thermoplastic fabrics are not suitable for mass production because they require the process of a hot press. Due to the hot press processing, the manufacturing speed of these two kinds of thermoplastic fabrics is slow. Further, these kinds of thermoplastic fabrics are not practical for making shaped hard shell members for home and office appliances.

### SUMMARY OF THE INVENTION

The present invention has been accomplished under the circumstances in view. It is one object of the present invention to provide a thermoplastic composite sheet material, which is practical for use to make shell members for electric and electronic products. It is another object of the present invention to provide a thermoplastic composite sheet material, which is practical for mass production. It is another object of the present invention to provide a thermoplastic composite sheet material, which can easily made subject to the desired thickness.

To achieve these and other objects of the present invention, the thermoplastic composite sheet material comprises a top fabric face layer digital-printed or transfer-printed with a design, a bottom thermoplastic sheet member, and a bonding agent sandwiched between the top fabric face layer and the thermoplastic sheet member. The thermoplastic composite sheet material can be injection-molded into different shell members having different shapes for different electric and electronic products.

### BRIEF DESCRIPTION OF THE DRAWINGS

FIG. 1 illustrates a reinforcing thermoplastic fiber thread according to the prior art.

FIG. 2 is a schematic drawing showing the composition of a thermoplastic fabric according to the prior art.

FIG. 3 is an exploded view of an exploded view of a thermoplastic composite sheet material according to the present invention.

FIG. 4A is an oblique elevation showing the finished status of the thermoplastic composite sheet material according to the present invention.

FIG. 4B is a sectional view in an enlarged scale of the thermoplastic composite sheet material shown in FIG. 4A.

FIG. 5 is a schematic drawing showing the processing of the present invention in an injection-molding machine.

FIGS. 6˜8 show application examples of the present invention.

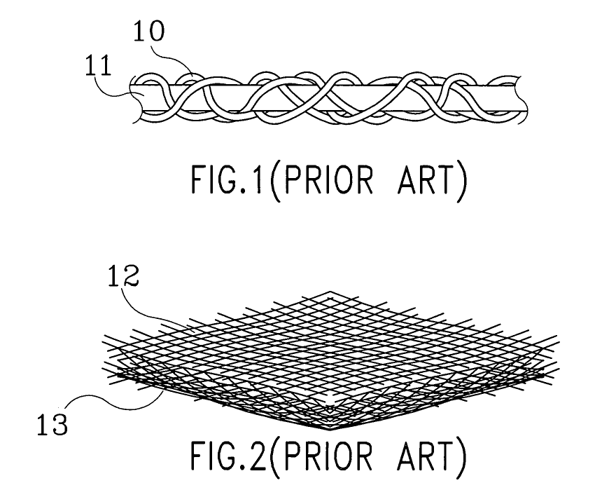

### DETAILED DESCRIPTION OF THE PREFERRED EMBODIMENT

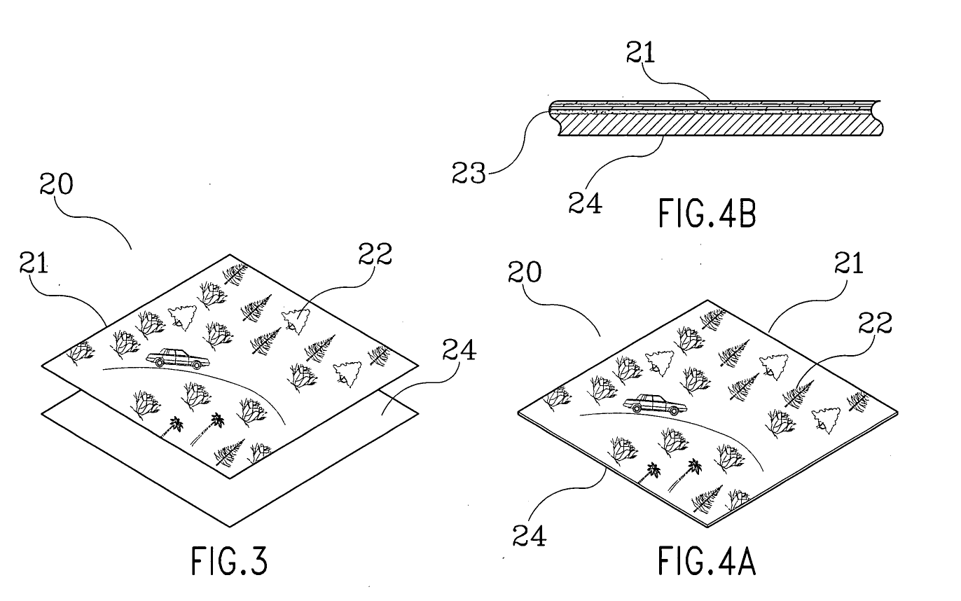

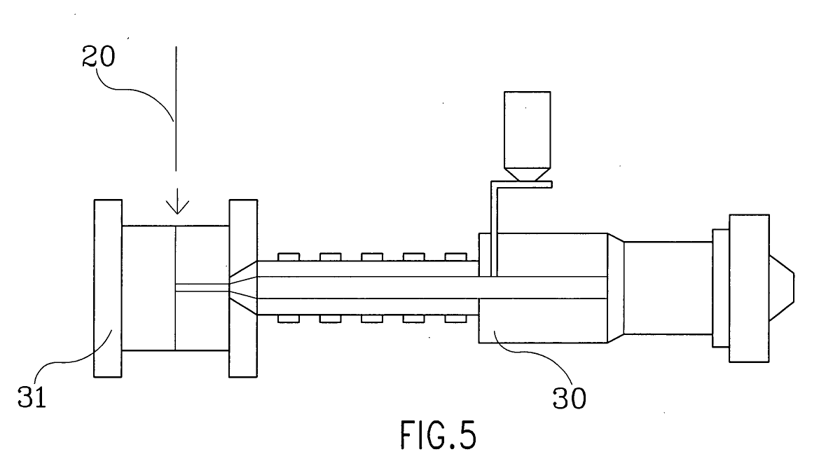

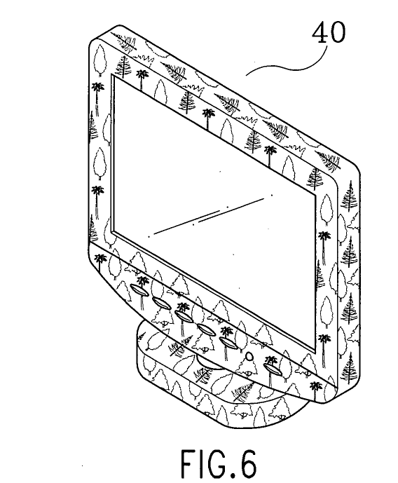

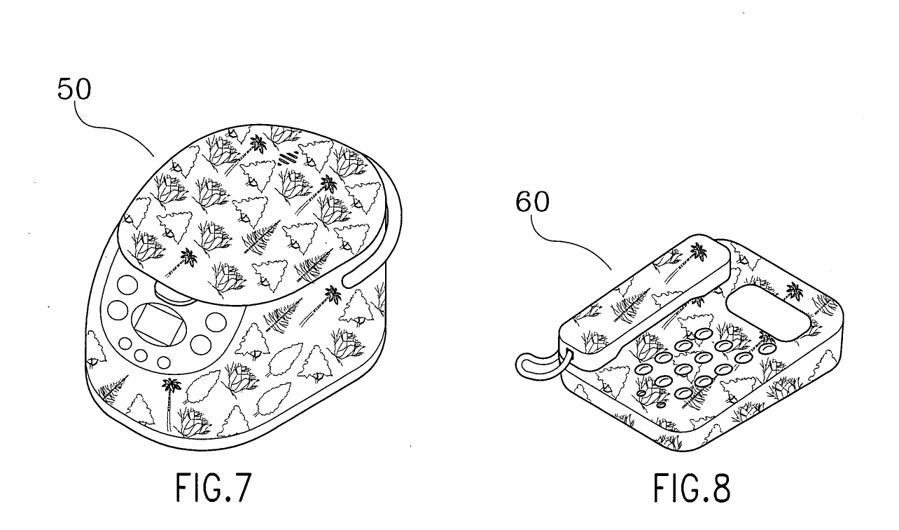

Referring to FIGS. 3, 4A and 4B, a thermoplastic composite sheet material 20 in accordance with the present invention is shown comprising a top fabric face layer 21 digital-printed or transfer-printed with a design 22, a bonding agent 23 covered over the bottom surface of the top fabric face layer 21, and a bottom thermoplastic sheet layer 24 bonded to the bonding agen 23. The top fabric face layer 21 is a woven fabric of any of a variety of natural fibers including cotton, wool, silk and linen, or any of a variety of synthetic fibers. The bonding agent 23 can be epoxy resin or polyester adhesive. The bottom thermoplastic sheet layer 24 can be formed of PP (Polypropylene), PC (Polycarbonate) or ABS (Acrylonitrile butadiene styrene).

As an alternate form of the present invention, the desired design can be directly digital-printed or transfer-printed on the bottom thermoplastic sheet layer 24. The transfer printing procedure is to digital print a selected ink on a transfer paper, and then transfer printed on the top fabric face layer 21 or the bottom thermoplastic sheet layer 24 through a thermal transfer printer. Instead of conventional screen printing techniques, the transfer printing procedure of the present invention through a thermal transfer printer is practical for mass production, thereby significantly reduce the manufacturing, cost. Further, the transfer printing procedure of the present invention eliminates the pollution problem of wastewater as encountered in screen printing techniques.

Referring to FIG. 5, the thermoplastic composite sheet material 20 is put in the mold 31 of a thermal injection-molding machine 30 and processed into the desired shape through a vacuum forming or laminating action. Alternatively, the bottom thermoplastic sheet layer 24 can be molded into the desired shape by means of a thermal injection-molding machine and then bonded to the bonding agent 23 at the bottom surface of the top fabric face layer 21 through a secondary injection molding process. After molding, the top fabric face layer 21 and the bottom thermoplastic sheet layer 24 are fixedly joined together, and the top fabric face layer 21 will never drop from the bottom thermoplastic sheet layer 24.

A thermoplastic composite sheet material in accordance with the present invention can be molded into different shapes for different purposes, for example, for use as the outer shells of any of a variety of products such as LCD monitor 40, electronic cooker 50, telephone 60, cell phone (not shown), and etc. The shape-formed bottom thermoplastic sheet layer 24 supports the top fabric face layer 21 in shape, and the top fabric face layer 21 gives a soft and comfortable touch.

A prototype of thermoplastic composite sheet material has been constructed with the features of FIGS. 3˜8. The thermoplastic composite sheet material functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A thermoplastic composite sheet material comprising a top fabric face layer, a bottom thermoplastic sheet member, a bonding agent sandwiched between said top fabric face layer and said thermoplastic sheet member, and a design printed on at least one of said top fabric face layer and said bottom thermoplastic sheet member.

2. The thermoplastic composite sheet material as claimed in claim 1, wherein said design is digital printed on at least one of said top fabric face layer and said bottom thermoplastic sheet member.

3. The thermoplastic composite sheet material as claimed in claim 1, wherein said design is transfer-printed on at least one of said top fabric face layer and said bottom thermoplastic sheet member.
